(19) United States
(12) Patent Application Publication
(10) Pub. No.: US 2026/0219833 A1
(43) Pub. Date: Jul. 30, 2026

(54) Car Communication Performance Enhancement With Occupancy Information

(71) Applicant: Panasonic Automotive Systems America, LLC., Peachtree City, GA (US)

(72) Inventor: CHRISTOPHER LEE SULLIVAN, NORTHVILLE, MI (US)

(21) Appl. No.: 19/574,430

(22) Filed: Mar. 22, 2026

Related U.S. Application Data
(63) Continuation-in-part of application No. 19/348,725, filed on Oct. 2, 2025.
(60) Provisional application No. 63/703,485, filed on Oct. 4, 2024.

(51) Int. Cl. G06F 3/16; H04R 1/08

(52) U.S. Cl. CPC G06F 3/165; H04R 1/08; H04R 2499/13

(57) ABSTRACT

An in-car communication arrangement includes a plurality of microphones disposed within a passenger compartment of the motor vehicle and each producing a respective microphone signal. A loudspeaker receives at least one of the microphone signals and produces audible sounds based on the at least one microphone signal. A plurality of seat occupancy sensors each determines whether a respective seat in the passenger compartment is occupied by a human occupant. An electronic processor is communicatively coupled to the microphones, the loudspeaker and the seat occupancy sensors. The electronic processor modifies the audible sounds dependent upon at least one of the signals from the occupancy sensors.

### CROSS-REFERENCE TO RELATED APPLICATIONS

This application, is a continuation-in-part of U.S. Nonprovisional application Ser. No. 19/348,725, filed: Oct. 2, 2025, which claims benefit of U.S. Provisional Application No. 63/703,485, filed on Oct. 4, 2024, the disclosures of which are hereby incorporated by reference in their entireties for all purposes.

### FIELD OF THE INVENTION

The disclosure relates to controlling the sound volume level of an infotainment system in a motor vehicle.

### BACKGROUND OF THE INVENTION

Holding a conversation in a motor vehicle can be difficult when there is loud music or other media content playing over the sound system. Often, occupants will manually turn down the volume (e.g., loudness) level of the vehicle's sound system in order to talk to each other, but this is not always a good solution. One problem is that sound system controls are often accessible only by front row occupants, so conversation cannot be easily initiated by a rear seat passenger. Another problem is that having to manually adjust sound system volume can be a distraction to the driver.

It is known for vehicles to include an in-car communication (ICC) system in which microphones in the passenger compartment pick up the voices of speaking passengers, and the speech is then played on the vehicle's loudspeakers. One way to reduce noise in the passenger compartment is by using microphone signal information to mute the microphones of occupants who are not speaking. This kind of processing is often referred to as a “noise gate.” The technique does provide benefits, and noise gates may be included in a well-designed ICC system on their own merit, but they have limitations. First, noise gates only affect the microphone side of the ICC system, not the speaker side. Second, noise gates are not infallible, and they become less reliable as the acoustic environment of the vehicle becomes more complex (e.g., more background noise, media playback, competing talkers, etc.). Third, noise gates must be always listening to the supported zones in order to mute effectively, so advanced processing such as Echo Cancellation Noise Reduction (ECNR) cannot be bypassed on unoccupied zones for computational load management.

### SUMMARY

The present invention may provide one or more microphones in a vehicle which pick up a mixture of sounds, including background noise, audio playback from the vehicle's sound system, and the speech of one or more occupants. A digital signal processing system may be applied to reduce the level of background noise and audio playback from the microphone signal(s), leaving only the occupants' speech.

Another digital signal processing system may be applied to the microphone signal(s) to detect when speech is present, which indicates that the occupants are trying to have a conversation. When conversation is detected, the inventive system may automatically reduce the volume of the vehicle's audio playback system to improve speech audibility and intelligibility for the conversing occupants. When the conversation ends and speech is no longer detected in the microphone signal(s), the proposed system will automatically increase audio playback volume back to its original level.

As used herein, the term “conversation” indicates that at least one person is talking. It is not necessary that multiple people speak for there to be a conversation.

In one embodiment, one or more microphones detect the presence of speech in a vehicle and reduce sound system volume accordingly. Thus, the invention may improve speech intelligibility by reducing the level of competing sound system playback.

In another embodiment, an in-car communication (ICC) system amplifies the detected speech signals through the vehicle's sound system to further improve speech intelligibility. The ICC system may use microphones in the vehicle to pick up speech and amplify the speech through the vehicle's sound system to improve intelligibility in the presence of noise. The ICC may increase the level of speech in the vehicle in order to overcome the level of existing background sounds.

In yet another embodiment, a subsystem detects which occupants in the vehicle are trying to communicate, and then reduces sound system volume selectively for only those occupants. As an example, assume that there are four occupants in a two-row vehicle, and the driver is trying to have a conversation with the front passenger. The level of the sound system volume may be reduced only for the front speakers nearest to the driver and front passenger, while leaving the rear speaker volume levels alone. The ICC system of the immediately preceding paragraph may be added to this embodiment to provide selective volume adjustment. More generally, an ICC system may be added to any embodiment of the invention that lacks an ICC system in order to improve speech intelligibility in a vehicle.

The invention may improve speech intelligibility by reducing the level of competing sound system playback. This may be a better solution than increasing the volume levels of speech through an ICC system when audio playback levels are already loud.

In one embodiment, an occupancy detection system in a vehicle determines how many passengers are present and in which seats they are seated. Occupancy detection may rely on in-seat pressure sensors, occupant monitoring cameras, or some other sensing device, such as the microphones of the ICC.

A microphone-based occupancy detection system should not be mistaken for noise gating. It is possible that microphone signals can be used to detect the presence and position of an occupant, regardless of whether they are talking. Using such a system to feed occupancy information to the ICC system falls within the scope of this invention.

An in-car communication (ICC) system operates in the vehicle, and includes one or more microphones and the vehicle's sound system. A set of digital signal processing (DSP) algorithms run on the ICC system. The ICC system amplifies occupants' voices through the vehicle sound system.

The occupancy information from the occupancy detection subsystem is passed to the ICC subsystem. The ICC subsystem can then adjust its operation automatically to improve performance for the current configuration of passengers in the vehicle.

The performance of the ICC system depends on the number and properties of acoustic feedback paths in the vehicle between active microphones and speakers. Configurations where many nearby microphones and speakers are active at the same time reduce the maximum stable voice amplification level. It is desirable to activate only microphones and speakers that support occupants that are present, and leave the remaining microphones and speakers inactive. For example, consider a three-row vehicle having six supported occupant zones of ICC with one microphone and one speaker mounted near each zone. If only the driver and one second-row passenger occupy the vehicle, it is inefficient to activate all six microphones and speakers for ICC. The best system performance (e.g., the greatest stable voice amplification level) is achieved when only the two microphones and speakers that are mounted nearest to the two occupants are enabled. Selectively enabling microphones and speakers can be handled automatically using occupancy information from the occupancy detectors to optimize ICC system performance.

In another example, consider the same vehicle with one centrally-mounted microphone array that picks up the voices of all occupants, instead of the vehicle having several near-mounted microphones. A DSP algorithm is used to extract different, individual voices from the single microphone array. In this case, the occupancy information can be used to adjust parameters of the DSP algorithm to focus the microphone array on only occupied regions of the vehicle, instead of selectively enabling/disabling microphones.

There are many possible ICC system adjustments that may benefit performance based on occupancy information, including selective microphone/speaker muting, microphone array focusing, echo cancellation/noise reduction (ECNR) parameter adjustment, gain limiting, feedback reduction profile adjustment, and processing load balancing. Which adjustments are appropriate and/or beneficial depends on the internal structure of the ICC system. This invention may pertain to any such adjustment that is made automatically based on occupancy detection information with the goal of improving ICC performance.

The present invention may provide a system including an occupancy detection subsystem and an ICC subsystem that uses information from the occupancy detection subsystem to drive performance enhancements to the ICC subsystem. The occupancy detection subsystem may include, for example, in-seat pressure sensors, cameras for performing occupancy recognition, microphones for performing occupancy recognition, and/or another occupancy detection system. The ICC subsystem may include a set of microphones, speakers, and DSP algorithms running on a digital processor that amplify occupants' voices throughout the vehicle. It is also possible to implement an ICC system with analog circuitry instead of a digital processor.

In one embodiment, the invention comprises an in-car communication arrangement for a motor vehicle. The arrangement includes a plurality of microphones disposed within a passenger compartment of the motor vehicle and each producing a respective microphone signal. A loudspeaker receives at least one of the microphone signals and produces audible sounds based on the at least one microphone signal. A plurality of seat occupancy sensors each determines whether a respective seat in the passenger compartment is occupied by a human occupant. An electronic processor is communicatively coupled to the microphones, the loudspeaker and the seat occupancy sensors. The electronic processor modifies the audible sounds dependent upon at least one of the signals from the occupancy sensors.

In another embodiment, the invention comprises an in-car communication method for a motor vehicle. The method includes providing a plurality of microphones within a passenger compartment of the motor vehicle. Each of the microphones produces a respective microphone signal. Audible sounds are produced based on at least one of the microphone signals. It is determined which seats in the passenger compartment are occupied by a human occupant. The audible sounds are modified dependent upon which seats in the passenger compartment are occupied by a human occupant.

In yet another embodiment, the invention comprises an in-car communication arrangement for a motor vehicle. The arrangement includes a plurality of microphones disposed within a passenger compartment of the motor vehicle and each producing a respective microphone signal. A loudspeaker receives at least one of the microphone signals and produces audible sounds based on the at least one microphone signal. An electronic processor is communicatively coupled to the microphones and to the loudspeaker. The electronic processor determines from the microphone signals which seats of the motor vehicle are occupied by a human occupant, and modifies the audible sounds dependent upon which seats of the motor vehicle are occupied by a human occupant.

### BRIEF DESCRIPTION OF THE DRAWINGS

A better understanding of the present invention will be had upon reference to the following description in conjunction with the accompanying drawings.

FIG. 1 is a block diagram of one embodiment of a sound volume control arrangement of the present invention.

FIG. 2 is a block diagram of another embodiment of a sound volume control arrangement of the present invention.

FIG. 3 is a block diagram of yet another embodiment of a sound volume control arrangement of the present invention.

FIG. 4 is a flow chart of one embodiment of a sound volume control method of the present invention for a motor vehicle.

FIG. 5 is a block diagram of one embodiment of an in-car communication arrangement of the present invention.

FIG. 6 is a block diagram of another embodiment of an in-car communication arrangement of the present invention.

FIG. 7 is a flow chart of one embodiment of an in-car communication method of the present invention for a motor vehicle.

### DETAILED DESCRIPTION OF THE PREFERRED EMBODIMENTS

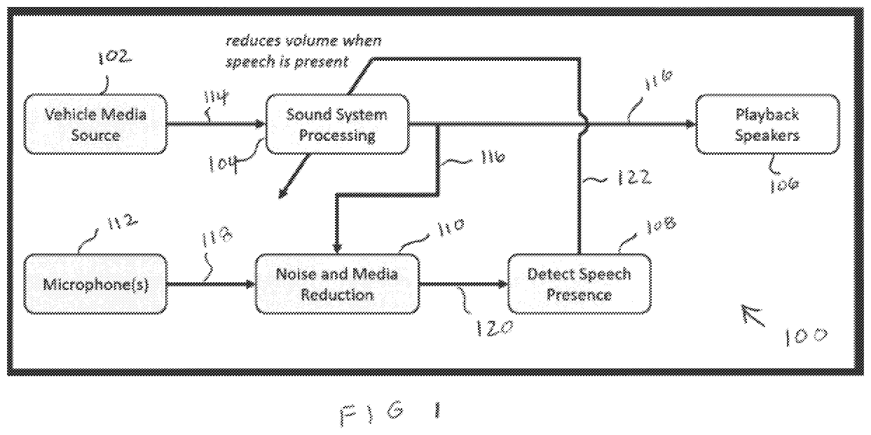

FIG. 1 illustrates one embodiment of a sound volume control arrangement 100 of the present invention, including a vehicle media content source 102, a sound system processor 104, playback loudspeakers 106, a speech presence detector 108, a noise and media content reduction block 110, and a microphone 112.

During use, vehicle media content source 102 produces an audio content signal 114 that may include recorded music content, for example. Sound system processor 104 receives signal 114 and transmits another audio content signal 116 that may be identical to signal 114 when there is no conversation going on. However, if it is determined that there is conversation going on in the vehicle, as described in more detail below, then audio content signal 116 may be a reduced-volume version of audio content signal 114.

Microphone 112 may pick up or detect any sounds within the passenger compartment of the vehicle and may produce a microphone signal 118 based on the detected sounds. Microphone signal 118 and audio content signal 116 are both received by noise and media content reduction block 110 where the audible content produced by content source 102 may be removed from microphone signal 118 to thereby produce a speech microphone signal 120.

Speech presence detector 108 receives and analyzes speech microphone signal 120 to determine whether a conversation is occurring in the vehicle. If it is determined that a conversation is occurring in the vehicle, then a volume reduction signal 122 is sent by speech presence detector 108. Volume reduction signal 122 is transmitted to and received by sound system processor 104, which then produces an audio content signal 116 that is a version of audio content signal 114 with reduced volume. If, however, it is determined that no conversation is occurring in the vehicle, then no volume reduction signal 122 is sent by speech presence detector 108. Audio content signal 116 then may be identical or substantially identical to audio content signal 114. Regardless of whether audio content signal 116 is volume-reduced or not, audio content signal 116 is converted into an audible sound by playback loudspeakers 106.

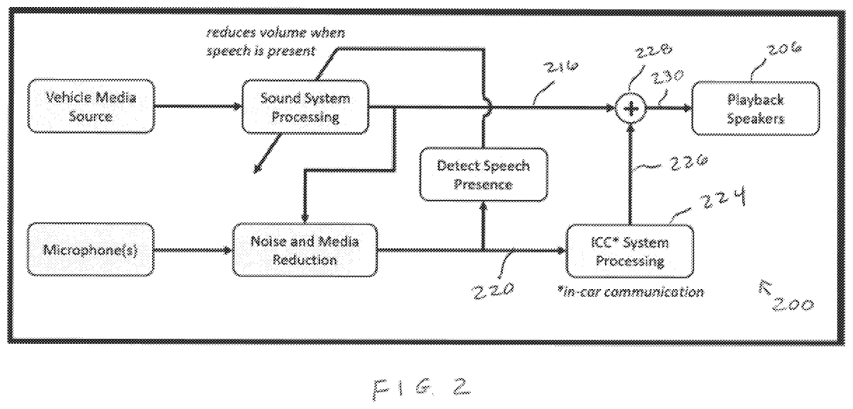

FIG. 2 illustrates another embodiment of a sound volume control arrangement 200 of the present invention. Arrangement 200 may be substantially similar to arrangement 100, except that arrangement 200 further includes an in-car communication (ICC) system processor 224 which receives speech microphone signal 220. Whatever speech is present in speech microphone signal 220 is represented in an ICC signal 226 produced by processor 224. ICC signal 226 may be added to an audio content signal 216 by a mixer 228 to produce an audio content with speech signal 230 that is converted into an audible sound by playback loudspeakers 206. Other features of arrangement 200 are substantially similar to those of arrangement 100, and thus are not described in detail herein in order to avoid needless repetition.

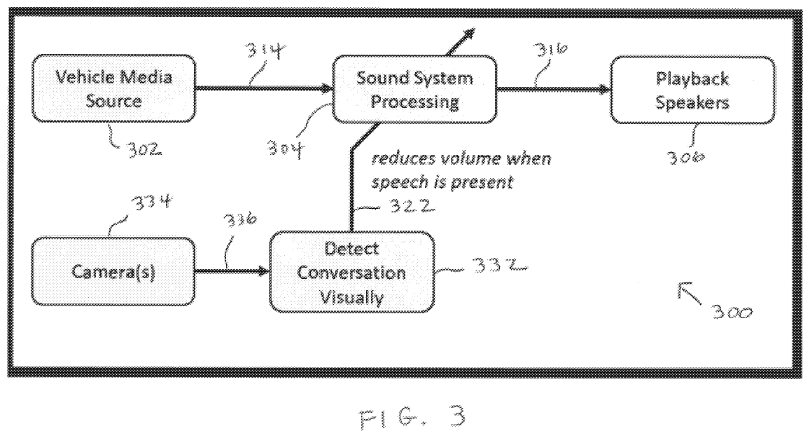

FIG. 3 illustrates yet another embodiment of a sound volume control arrangement 300 of the present invention, including a vehicle media content source 302, a sound system processor 304, playback loudspeakers 306, a visual conversation detector 332, and cameras 334.

During use, vehicle media content source 302 produces an audio content signal 314 that may include recorded music content, for example. Sound system processor 304 receives signal 314 and transmits another audio content signal 316 that may be identical to signal 314 when there is no conversation going on. However, if it is determined that there is conversation going on in the vehicle, as described in more detail below, then audio content signal 316 may be a reduced-volume version of audio content signal 314.

Cameras 334 may capture images of the mouths of any human passengers within the passenger compartment of the vehicle and may produce video signals 336 based on the captured images. Video signals 336 are received by visual conversation detector 332 which analyzes video signals 336 to determine whether a conversation is occurring in the vehicle. For example, if video signals show that at least one occupant's lips are moving in a way that is indicative of speech, then it may be determined that a conversation is occurring. If it is determined that a conversation is occurring in the vehicle, then a volume reduction signal 322 is sent by visual conversation detector 332. Volume reduction signal 322 is transmitted to and received by sound system processor 304, which then produces an audio content signal 316 that is a version of audio content signal 314 with reduced volume. If, however, it is determined that no conversation is occurring in the vehicle, then no volume reduction signal 322 is sent by visual conversation detector 332. Audio content signal 316 then may be identical or substantially identical to audio content signal 314. Regardless of whether audio content signal 316 is volume-reduced or not, audio content signal 316 is converted into an audible sound by playback loudspeakers 306.

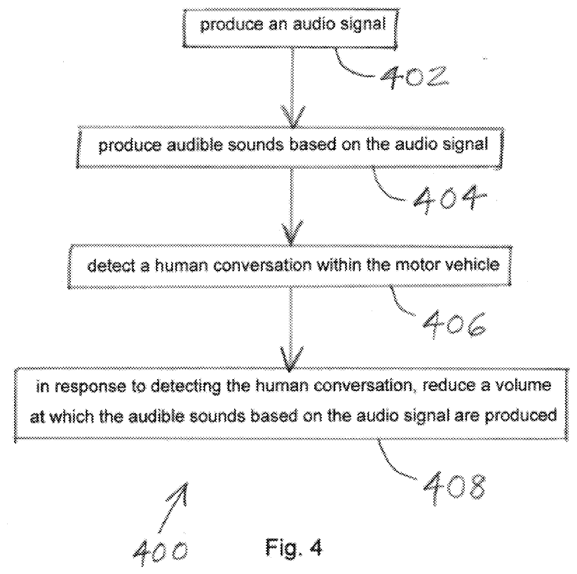

FIG. 4 illustrates one embodiment of a sound volume control method 400 of the present invention for a motor vehicle. In a first step 402, an audio signal is produced. For example, vehicle media content source 102 produces an audio content signal 114 that may include recorded music content. Sound system processor 104 receives signal 114 and transmits another audio content signal 116 that may be identical to signal 114 when there is no conversation going on.

Next, in step 404, audible sounds are produced based on the audio signal. For example, audio content signal 116 is converted into an audible sound by playback loudspeakers 106.

In a next step 406, a human conversation within the motor vehicle is detected. For example, microphone 112 may pick up or detect any sounds within the passenger compartment of the vehicle and may produce a microphone signal 118 based on the detected sounds. Microphone signal 118 and audio content signal 116 are both received by noise and media content reduction block 110 where the audible content produced by content source 102 may be removed from microphone signal 118 to thereby produce a speech microphone signal 120. Speech presence detector 108 receives and analyzes speech microphone signal 120 to determine whether a conversation is occurring in the vehicle.

In a final step 408, in response to detecting the human conversation, a volume at which the audible sounds based on the audio signal are produced is reduced. For example, if it is determined that a conversation is occurring in the vehicle, then a volume reduction signal 122 is sent by speech presence detector 108. Volume reduction signal 122 is transmitted to and received by sound system processor 104, which then produces an audio content signal 116 that is a version of audio content signal 114 with reduced volume.

The invention may be implemented by a set of digital signal processing systems, but it is also possible to implement the speech detection and volume adjustment stages with analog circuitry.

Instead of microphones to detect the presence of conversation in the vehicle, it is possible to use cameras to watch for mouth movements of the occupants. Such a configuration may support embodiments in which the level of competing sound system playback is decreased.

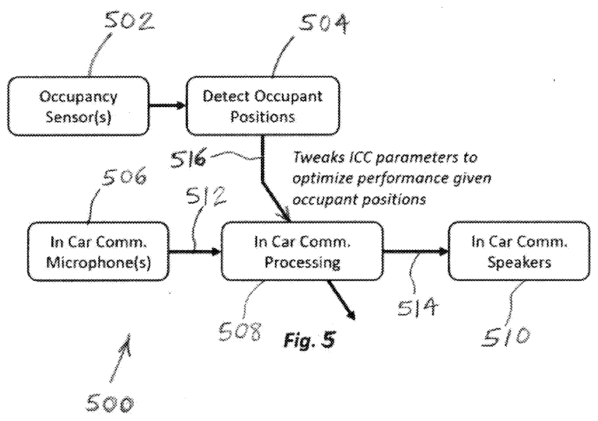

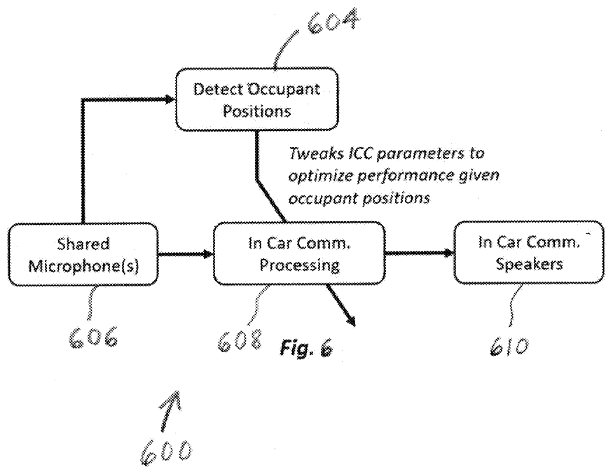

FIGS. 5-6 are directed to in-car communication performance enhancement with occupancy information. FIG. 5 illustrates one embodiment of an in-car communication arrangement 500 of the present invention, including occupancy sensor(s) 502, an occupant positions detecting block 504, in-car communication microphone(s) 506, an in-car communication processing block 508, and in-car communication loudspeakers 510. Occupancy sensors 502 may include in-seat pressure sensors and/or occupant monitoring cameras, for example. Occupancy sensors 502 may each be installed in/on, next to, or in association with a respective seat or group of seats (not shown) in a motor vehicle. Microphones 506 may each be located next to, near, or otherwise associated with a respective seat or group of seats (not shown) in the motor vehicle. Alternatively, microphones 506 may be arranged in one or more clusters or arrays of microphones, such as in a single cluster or array of microphones that is centrally-located in the vehicle's passenger compartment. Speakers 510 may each be located next to or near a respective seat or group of seats (not shown) in the motor vehicle.

During use, occupancy sensor(s) 502 detect the occupants' positions in the vehicle (block 504). For example, occupancy sensor(s) 502 may determine which seats in the vehicle are occupied by a person. This occupancy information may be passed to the ICC system's processing block 508, which then amplifies voices captured by the ones of microphones 506 that are associated with the seat that have been determined to be occupied by a human occupant. The amplified voices captured by these microphones 506 are then played on the vehicle's speakers 510. Thus, the occupants can better hear the voices of other occupants without hearing the noisy signals captured by microphones 506 that are not associated with an occupied seat. More generally, the ICC subsystem 506, 508, 510 uses seat occupancy information to tweak ICC parameters to optimize performance of the ICC subsystem.

FIG. 6 illustrates another embodiment of an in-car communication arrangement 600 of the present invention wherein microphones 606 are shared between the ICC and occupancy detection subsystems. That is, microphones 606 are used in block 604 to determine which seats are occupied by humans. For example, if a microphone 606 that is next to a particular seat produces a microphone signal that has relatively large amplitudes, particularly in the speech frequency range, then it may be determined that the particular seat is occupied by a human occupant. These microphone signals that are indicative of speech may be further amplified in block 608 for playing on speakers 610. Thus, the occupants can better hear the voices of other occupants without hearing the noisy signals captured by microphones 606 that are not associated with an occupied seat. Other features of arrangement 600 are substantially similar to those of arrangement 500, and thus are not described in detail herein in order to avoid needless repetition.

Arrangements 100, 200, 300, 500 and 600 may each be installed in a respective motor vehicle.

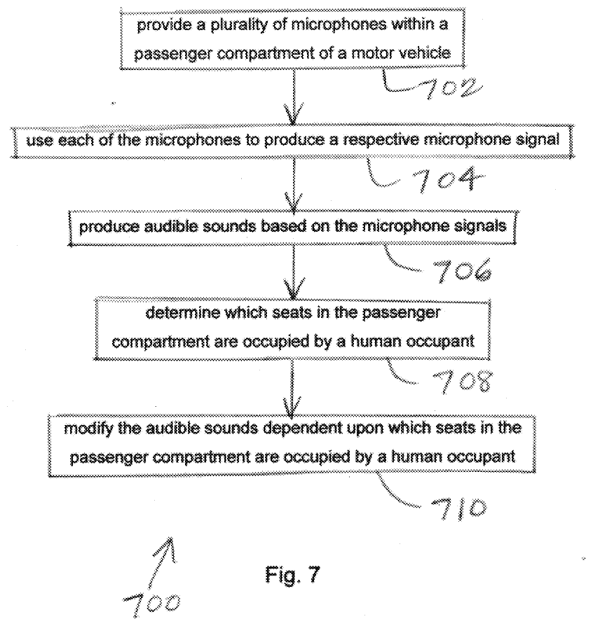

FIG. 7 illustrates one embodiment of an in-car communication method 700 of the present invention for a motor vehicle. In a first step 702, a plurality of microphones are provided within a passenger compartment of the motor vehicle. For example, microphones 506 may be provided within a passenger compartment of a motor vehicle, with each microphone 506 being disposed next to and closest to a respective one of the seats.

Next, in step 704, each of the microphones is used to produce a respective microphone signal. For example, each microphone 506 may produce an electronic microphone signal 512 that is representative of the sounds that the microphone 506 picks up. Each microphone signal 512 is likely to be dominated by the voice of any person who may be sitting in the seat that is closest to the microphone 506.

In a next step 706, audible sounds are produced based on at least one of the microphone signals 512. For example, a loudspeaker 510 may receive processed versions 514 of microphone signals 512.

In step 708, it is determined which seats in the passenger compartment are occupied by a human occupant. For example, outputs of occupancy sensors 502 in the form of in-seat pressure sensors, cameras, or microphones may be used in block 504 to detect which seats of the motor vehicle are occupied by an occupant.

In a final step 710, the audible sounds are modified dependent upon which seats in the passenger compartment are occupied by a human occupant. For example, processing block 508 may modify signals 514 based on seat occupancy signals 516 output by occupant detecting block 504. In one embodiment, processing block 508 deletes microphone signals 512 from microphones 506 next to unoccupied seats, and passes on to speakers 510 only microphone signals 512 from microphones 506 next to occupied seats.

The invention has been described as automatically optimizing ICC performance for an occupancy configuration. However, another way to optimize ICC performance for an occupancy configuration within the scope of the invention is manually. A user interface may provide the driver and/or occupants with fine control over ICC voice routing among supported zones. This makes it more complicated for a human user to use the ICC system, however, and it may be distracting to use while driving. When occupancy detection information is available, the ICC user interface may be simplified to fewer controls, such as perhaps only: “on”, “off”, and “volume”.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An in-car communication arrangement for a motor vehicle, the arrangement comprising:
a plurality of microphones disposed within a passenger compartment of the motor vehicle and each configured to produce a respective microphone signal;
a loudspeaker configured to receive at least one of the microphone signals and produce audible sounds based on the at least one microphone signal;
a plurality of seat occupancy sensors each configured to determine whether a respective seat in the passenger compartment is occupied by a human occupant; and
an electronic processor communicatively coupled to the microphones, the loudspeaker and the seat occupancy sensors, the electronic processor being configured to modify the audible sounds dependent upon at least one of the signals from the occupancy sensors.

2. The in-car communication arrangement of claim 1 wherein each of the microphones is a closest one of the microphones to a respective one of the seats in the passenger compartment.

3. The in-car communication arrangement of claim 1 wherein the seat occupancy sensors comprise in-seat pressure sensors.

4. The in-car communication arrangement of claim 1 wherein the seat occupancy sensors comprise cameras.

5. The in-car communication arrangement of claim 1 wherein the seat occupancy sensors comprise the microphones.

6. The in-car communication arrangement of claim 1 wherein the electronic processor is configured to enable ones of the microphones that are closest to at least one occupied said seat, and disable ones of the microphones that are not closest to at least one occupied said seat.

7. The in-car communication arrangement of claim 1 wherein the electronic processor is configured to perform at least one of selective microphone muting, selective loudspeaker muting, microphone array focusing, echo cancellation/noise reduction (ECNR) parameter adjustment, gain limiting, feedback reduction profile adjustment, and processing load balancing dependent upon at least one of the signals from the occupancy sensors.

8. An in-car communication method for a motor vehicle, the method comprising:
providing a plurality of microphones within a passenger compartment of the motor vehicle;
using each of the microphones to produce a respective microphone signal;
producing audible sounds based on at least one of the microphone signals;
determining which seats in the passenger compartment are occupied by a human occupant; and
modifying the audible sounds, the modifying being dependent upon which seats in the passenger compartment are occupied by a human occupant.

9. The in-car communication method of claim 8 wherein each of the microphones is a closest one of the microphones to a respective one of the seats in the passenger compartment.

10. The in-car communication method of claim 8 wherein the determining step is performed using in-seat pressure sensors.

11. The in-car communication method of claim 8 wherein the determining step is performed using cameras.

12. The in-car communication method of claim 8 wherein the determining step is performed using the microphones.

13. The in-car communication method of claim 8 wherein the modifying step includes enabling ones of the microphones that are closest to at least one occupied said seat, and disable ones of the microphones that are not closest to at least one occupied said seat.

14. The in-car communication method of claim 8 wherein the modifying step includes performing at least one of selective microphone muting, selective loudspeaker muting, microphone array focusing, echo cancellation/noise reduction (ECNR) parameter adjustment, gain limiting, feedback reduction profile adjustment, and processing load balancing dependent upon which seats in the passenger compartment are occupied by a human occupant.

15. An in-car communication arrangement for a motor vehicle, the arrangement comprising:
a plurality of microphones disposed within a passenger compartment of the motor vehicle and each configured to produce a respective microphone signal;
a loudspeaker configured to receive at least one of the microphone signals and produce audible sounds based on the at least one microphone signal; and
an electronic processor communicatively coupled to the microphones and the loudspeaker, the electronic processor being configured to:
determine from the microphone signals which seats of the motor vehicle are occupied by a human occupant; and
modify the audible sounds, the modifying being dependent upon which seats of the motor vehicle are occupied by a human occupant.

16. The in-car communication arrangement of claim 15 wherein each of the microphones is a closest one of the microphones to a respective one of the seats in the passenger compartment.

17. The in-car communication arrangement of claim 15 wherein the electronic processor is configured to enable ones of the microphones that are closest to at least one occupied said seat, and disable ones of the microphones that are not closest to at least one occupied said seat.

18. The in-car communication arrangement of claim 15 wherein the electronic processor is configured to perform at least one of selective microphone muting and selective loudspeaker muting dependent upon which seats of the motor vehicle are occupied by a human occupant.

19. The in-car communication arrangement of claim 15 wherein the electronic processor is configured to perform at least one of microphone array focusing and echo cancellation/noise reduction (ECNR) parameter adjustment dependent upon which seats of the motor vehicle are occupied by a human occupant.

20. The in-car communication arrangement of claim 15 wherein the electronic processor is configured to perform at least one of gain limiting, feedback reduction profile adjustment, and processing load balancing dependent upon which seats of the motor vehicle are occupied by a human occupant.
